(19) United States
(12) Patent Application Publication
(10) Pub. No.: US 2002/0156574 A1
(43) Pub. Date: Oct. 24, 2002

(54) Snow groomer having improved electronic controls

(76) Inventor: Manon Fortin, Quebec (CA)

Correspondence Address: PILLSBURY WINTHROP, LLP, P.O. BOX 10500, MCLEAN, VA, 22102, US

(21) Appl. No.: 09/937,827

(22) PCT Filed: Jan. 29, 2001
(86) PCT No.: PCT/CA01/00088

(51) Int. Cl. G01C 21/34

(52) U.S. Cl. 701/213

(57) ABSTRACT

A snow grooming device suitable for grooming ski hills, trails, or other snow park areas is provided with one or more of a series of improved electronic controls and/or instrumentation that can include track adjustment position control, tiller pressure control, ignition control and data collection, slope angle, halfpipe tool angle, tiller positioning, winch operational data, figure-8 counter, snow profiler, vehicle trace, and weather information. Depending on the particular result desired and the actual operating conditions, these controllers and instruments can be used independently or, in various combinations to improve the performance of the device, the efficiency of the snow grooming operation, the life of particular components, and the information available for the evaluation and tracking of slope condition.

This application claims priority from U.S. provisional application 60/178,774 filed Jan. 28, 2000, the contents of which are incorporated herein by reference.

### FIELD OF INVENTION

This invention relates to snow grooming devices for snow areas and, more particularly, the invention is directed to control and instrumentation systems for snow grooming vehicles.

### BACKGROUND OF THE INACTION

At modern ski resorts, with increased skier traffic and the frequent need to accommodate a wide variety of ski terrain, skier skills, interests, and equipment, snow making and snow grooming have become essential operations at any successful ski center. Tracked vehicles are widely used in these operations, providing the propulsion and/or power for a number of snow grooming attachments including plows, tillers, and halfpipe tools.

Generally, a tracked vehicle used in a grooming operation has a blade on the front for collecting snow from areas where there is too much and moving it to areas which are worn or require an excess of snow for the creation of particular snow profiles. The tracked vehicle may also include a tiller attached to the rear that breaks up ice chunks or other undesirable types of snow.

Typical snow grooming vehicles use manually controlled and adjusted implements. Such manual control makes it difficult to obtain carefully groomed snow surfaces, especially surfaces that require special grooming techniques, have irregular terrain, or contain unmarked obstacles.

One of the problems encountered by traditional snow grooming devices is slippage of the track that propels the vehicle. During grooming operations, it is preferable to reduce track slippage as much as possible as track slippage may damage or blemish the snow surface or formation the grooming operation is intended to produce. Current tracked vehicles rely on the operator to reduce track slippage by manually adjusting the speed of the tracked vehicle or manually adjusting the position of the wheels around which the track is arranged to adjust the track tension. Current tracked vehicles do not provide dynamic monitoring and control of track tension, nor do current tracked vehicles provide dynamic setting of a target track tension either automatically or by the operator.

Other problems encountered during grooming relate to controlling the tiller. The tiller can be provided in a variety of configurations and employ a variety of control systems. One such tiller configuration, disclosed in U.S. patent application Ser. No. 60/172,157, which was filed on Dec. 17, 1999 and is incorporated herein by reference, includes a plurality of tiller subassemblies, each subassembly including at lease one tiller element, coupled with a control system for adjusting the relative orientation of the tiller subassemblies to provide automatic control of the tiller for safely maintaining a selected snow profile.

Other variations to the tiller assembly itself have been used to provide greater control over the tiller performance. For example, the volume and configuration of the incorporated snow chamber may be varied during snow grooming operation according to the teachings of U.S. Pat. No. 5,067,263 to Pelletier, which is incorporated herein by reference. A flexible mat (or mats) having grooved finishing elements is generally provided at the rear of the tiller assembly to provide the final snow surface conditioning by smoothing or, alternatively, by providing a “corduroy” texture to the surface of the tilled snow. U.S. Pat. No. 5,067,263 does not disclose or suggest, however, dynamically providing information to the operator regarding the tiller chamber, pressure, position, and direction and dynamic control of the tiller chamber, pressure, position, and direction during grooming operations.

U.S. Pat. No. 5,632,106 to Sinykin, which is herein incorporated by reference, discloses a tiller with an adjustable depth cutter and snow comb entry angle including an adjustable cover that directs the snow to the snow comb. The operator determines the till depth and time in response to snow conditions. U.S. Pat. No. 5,632,106 does not disclose or suggest dynamically providing information regarding the tiller pressure and direction to the operator and dynamically controlling the tiller pressure and direction during grooming operations.

Current tiller assemblies also may include a relief valve that reduces the tiller pressure upon detection of a pressure exceeding a threshold value. The pressure must be manually re-increased or recharged, however, in the event that the tiller pressure is reduced. The operator must then discontinue the grooming operation to manually recharge the pressure.

Determining the vehicle path and controlling the vehicle based on terrain are also problems experienced by operators of snow grooming vehicles. Typically, during grooming, the operator manually monitors and controls the tracked vehicle's path to maintain a desired grooming path or configuration relative to the grooming staring position. Current tracked vehicles do not include the ability to dynamically monitor and display the vehicle's tilt and roll angles relative to the starting position and the slope being groomed. Therefore, the skill of the operator is relied upon to control the vehicle to accurately groom the slope.

In order to groom steep slopes, the tracked vehicle including a blade, a tiller, and/or other grooming device, may also include a winch and cable. The cable is attached to the top of the slope and guides and supports the tracked vehicle while it performs grooming operations along the slope. When the vehicle turns, the cable inherently twists. To avoid undue twisting of the cable, operators must remember to alternate turning and must be careful to alternately turn the tracked vehicle left and right in a figure-8 motion. Presently, the operator must device his own mental system to keep track of the number and direction of each left and right turn during the grooming operation If the operator fails to alternate correctly between the number of left and right turns, the cable will become twisted and may become damaged and possibly break.

A further problem encountered during grooming is the lack of information about the surface. As snow depth varies and obstacles are often obscured by snow, it is difficult for an operator to adjust the grooming operation to account for variations in the surface condition. To accurately perform grooming operations, it is necessary to have accurate and complete information regarding the snow depth at each point of the snow area. The snow depth should be controlled by moving snow from areas where there is more than needed to perform the grooming operations to areas where there is less than needed to perform grooming operations, so that it is unnecessary to make snow.

U.S. Pat. No. 5,761,095 to Warren discloses a system for monitoring the depth of snow that includes global positioning system and an initialization unit that generates ground surface data representative of the surface of the ground without snow and a snow surface data acquisition unit that generates snow surface data representative of the surface of the snow. The difference between the snow surface data and the ground surface data is then used to generate snow depth data representative of the area between the ground and snow surfaces.

U.S. Pat. No. 5,761,095 does not disclose or suggest, however, dynamically collecting, displaying, and recording snow depth data during snow grooming operations, including displaying an instant snow depth corresponding to the tracked vehicle's location during a snow grooming operation and/or a snow depth history of the tracked vehicle's path during a snow grooming operation. In addition, U.S. Pat. No. 5,761,095 does not disclose or suggest dynamically displaying and recording a trace of the vehicle's path over a map of the snow area during a grooming operation so that an operator or even a base location can monitor the vehicles progress with respect to obstacles in the terrain.

Problems encountered during grooming have also increased with respect to the special terrain features that many resorts now provide, especially snow boarding features. The popularity of snow boarding has caused many ski centers to form halfpipe ramps for snow board use. Currently, tools used to form halfpipe ramps are manually controlled by the operator. This is difficult when maneuvering on a slope, especially when the terrain or snow conditions are variable. Presently, there does not exist a control mechanism for a halfpipe tool that allows for dynamic monitoring and manipulation of the halfpipe tool during formation of the halfpipe ramp.

At the present time, much of the actual operation of the snow grooming vehicle remains in the direct manual control of the operator who is provided with a limited amount of information regarding the conditions of the tools and terrain. Although many operators are quite skilled, their ability to create, accurately and efficiently, the desired snow conditions and profiles varies, limited in part by the complexity inherent in consistently coordinating the action of the various components and operations of the snow grooming vehicle and by the scope and format of information readily available to the operator. There remains, therefore, a need to provide more automated control and expand the scope and utility of information available to the operator and others.

### SUMMARY OF THE INVENTION

The invention provides a number of control and data collection/display features that can be incorporated into a vehicle for improving the snow grooming operation and aiding the operator in efficiently achieving the desired snow profiles.

It is therefore an aspect of the invention to provide improved control over various facets of snow grooming operation.

It is also an aspect of the invention to provide data having expanded scope and improved format available to the snow grooming operator to assist in the efficient operation of the vehicle.

Another aspect of the invention provides an operator-specific data collection and interface system that controls certain aspects of the tiller operation and provides a means for data collection and transfer.

The invention can also provide an operator-specific data collection and interface system that controls certain aspects of the track tension adjuster and provides a means for automatic and manual reduction of track slippage.

Additionally, an operator-specific data collection and interface system can be provided that controls certain aspects of a halfpipe tool operation and provides a means for data collection and transfer.

Another aspect of the invention provides an operator-specific data collection and interface system that controls certain aspects of the vehicle operation on sloped snow areas and provides a means for data collection and transfer.

Further, the invention can provide an operator-specific data collection and interface system that controls certain aspects of a vehicle winch and vehicle operation during use of the winch and provides a means for data collection and transfer.

The invention can also provide for an operator-specific data collection and interface system that controls certain aspects of snow depth data collection and display and provides a means for data collection and transfer.

Also, an operator-specific data collection and interface system can be provided to control certain aspects of mapping the vehicle's path over a snow area, display the vehicle's A position and trace the vehicle's path over a map of the snow area and to provide a means for data collection and transfer.

It is to be understood that the invention described herein can be varied in a number of ways and is not restricted to the particular embodiments described below, but generally includes any vehicle that incorporates one or more of the disclosed control or data collection elements to assist in snow grooming.

### BRIEF DESCRIPTION OF THE DRAWINGS

The invention will be described in greater detail in conjunction with the following drawings wherein:

FIG. 1 is a schematic of a vehicle including a track tension control system according to one embodiment of the invention;

FIG. 2 is a schematic of vehicle including a tiller up-down position control system according to one embodiment of the invention;

FIG. 3 is a schematic of a data and mapping collecting and transferring system according to one embodiment of the invention;

FIGS. 4(a)-4(c) are representations of slope angle calculation and display systems according to one embodiment of the invention;

FIGS. 5(a) and 5(b) are representations of a halfpipe tool angle calculation and display system according to one embodiment of the invention;

FIGS. 6(a) and 6(b) are representations of a tiller information collection and display system according to one embodiment of the invention;

FIGS. 7(a)-7(c) are representations of a Figure-8 counting, winch information collection and display system according to one embodiment of the invention;

FIGS. 8(a) and 8(b) are representations of a weather information collection and display system according to one embodiment of the invention; and

FIGS. 9(a) and 9(b) are representations of a snow depth information collection and display system according to one embodiment of the invention.

### DETAILED DESCRIPTION OF EXEMPLARY EMBODIMENTS

The system described herein is explained in conjunction with a tracked vehicle having snow grooming implements. The various systems are used to provide automatic and dynamic operation of the snow grooming implements and vehicle. It is understood that such systems could be used independently or in any number of combinations depending on the desired use. It is also understood that the various systems can be used on different vehicles and devices and is not limited to the tracked snow grooming device described herein.

To provide an operator with information and dynamic automatically controlled functions, the following systems explained in detail below are provided in accordance with this invention. The device can be provided with the following functions: track slippage control; track tension adjustment control; tiller pressure control; a memory card and data module; slope angle control and display; half-pipe tool angle control and display; tiller control and display; figure-8 count and display; winch control and display; weather information collection and display; snow depth information collection and display, and, vehicle position trace control and display.

These systems can be implemented by connection to the eating electronic system in a snow grooming vehicle or can be provided as separate components and connected to the vehicle in a manner as would be known by one of ordinary skill in the art.

The systems are hereafter described separately in detail.

Track Slippage Control

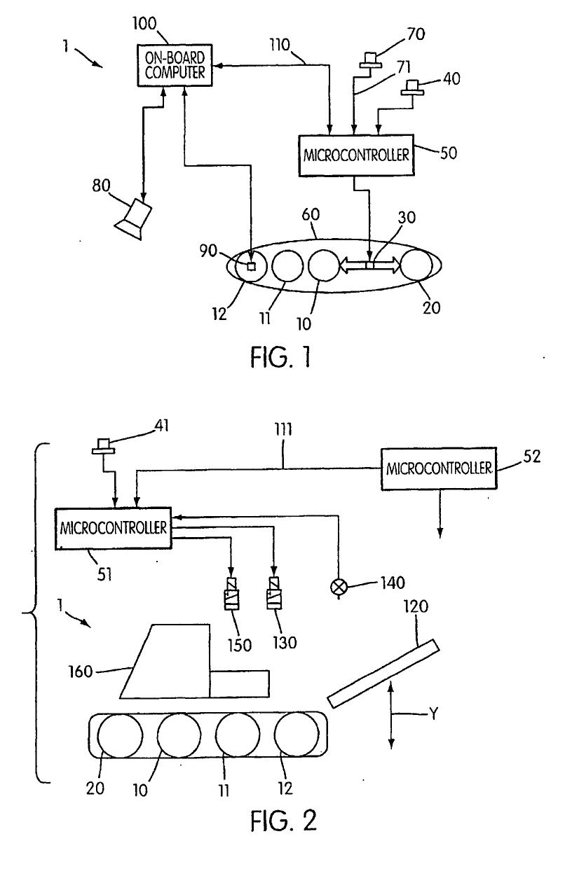

Referring to FIG. 1, one of the parameters of particular concern during the operation of the vehicle 1 is track slippage, i.e., linear movement of the track 60 that exceeds the linear movement of the vehicle 1. According to the invention, in addition to the automatic track tension adjustment control by the microcontroller 50, the operator has the ability to reduce the track slippage manually by incrementing the track adjuster position.

For instance, should the operator detect unacceptable track slippage, the operator can toggle a switch 70 to a “release position.” Each time the switch 70 is toggled, the target track adjuster position of the track adjuster 30 will be decreased by a predefined increment, typically less than one inch, to reduce the track tension and reduce track slippage.

According to one embodiment of the invention, the presence of a track slippage condition will be automatically detected by using a combination of speed radar 80 and at least one track speed sensor 90, which may be, for example, a motor speed sensor. Any difference between track speed and ground speed indicates that a track slippage condition exists and the measured speed values and the detected difference may be used to calculate a corresponding track slippage percentage that can be continuously or intermittently displayed to the operator.

The calculated track slippage percentage can also be monitored by the microcontroller 50 and compared with a predetermined value so if excessive track slippage is detected, the track adjuster position can be adjusted automatically to reduce track slippage. The microcontroller 50 can also be configured to provide a visual and/or auditory alert to the operator that an excessive track slippage has been detected or is likely to occur unless corrective action is taken

In a preferred embodiment of the invention, the vehicle tracks 60 include a large rubber band or belt with metal cross-links arranged around a plurality of aligned wheels 10, 11, 12, and 20. The track adjuster 30 may include a hydraulic cylinder installed between the two forwardmost wheels 10 and 20 on each side of the vehicle 1. Extending the cylinder will move the front wheel 20 forward relative to the fixed position of the second wheel 10, increasing the distance between the two wheels 10 and 20. Increasing this distance results in a corresponding increase to the track tension Similarly, retracting the cylinder will move the front wheel 20 backward, bringing the wheels 10 and 20 closer together, thus reducing the track tension.

The movement and position of the track adjuster cylinder is monitored and controlled by the microcontroller 50. The target cylinder position is set in the microcontroller 50 using a potentiometer installed in the vehicle cab 160 as the operator input 40. In response to the target position input and the detected track adjuster position, the microcontroller 50 will activate and adjust the appropriate hydraulic valves until a cylinder position sensor 35 indicates that the target position has been reached. The cylinder position is constantly monitored by the microcontroller 50. If an external event shifts the position of the track adjuster 30, the microcontroller 50 will automatically reposition the track adjuster 30 to reestablish the target position.

In some instances, it may not be convenient or advisable to adjust the track adjuster target position (as set by the potentiometer of the operator input 40) during vehicle operation. To accommodate “on-the-fly” adjustments, the invention provides the switch 70, installed, for example on the dashboard, to provide incremental adjustments of track tension. Depending on the conditions, the operator can toggle the switch 70 to adjust the track tension by incremental movements of the track adjuster 30.

If, for example, the operator wishes to reduce the track tension (as this would be desired in case of slippage), the operator would toggle the switch 70 to send a signal 71 to the microcontroller 50. In response to the signal 71, the microcontroller 50 will establish a new retracted target position for the track adjuster 30 and operate the appropriate hydraulic circuits and valves to automatically retract the cylinder of the track adjuster 30 to the new target position. Typically the increment of adjustment in the target track adjuster position would be less than one inch (approx. ¾″ or approx. 19 mm), but may be set as desired.

When the vehicle 1 is climbing up a slope or working against a particular load, the track 60 will tend to slip. Track slippage is not desired because it can damage the snow surface as the track 60 churns and digs into the snow. One way to reduce the track slippage is to reduce the track tension. This reduction in track tension produces additional grip for the track 60.

In order to automatically improve the situation, an on-board computer 100, installed in the vehicle cab 160 monitors the track slippage. This may be done by comparing the track speed (by sensing the motor speed using the motor speed sensor 90) with the actual speed (given by the speed radar 80 installed on the vehicle 1). Using these measured values, the on-board computer 100 can calculate a percentage of slippage. If the slippage percent exceeds a preset value, the on-board computer 100 will send a signal 110 to the microcontroller 50. The microcontroller 50 will then retract the cylinder of the track adjuster 30 a predefined distance (approx. ¾″ or approx. 19 mm) to reduce the belt tension and reduce the track slippage.

Track Tension Adjustment Control

Track tension can also be adjusted. Referring to FIG. 1, the track tension on a vehicle 1, for example a tracked snow grooming vehicle, is typically determined by the relative spacing of fixed and moveable components, for instance wheels, plates, or other track guides. According to one embodiment of the invention, the track tension is determined by the spacing between a fixed wheel 10 and a moveable wheel 20. The position of the moveable wheel 20 is determined by the movement of a track adjuster 30, such as a hydraulic piston assembly, over a known range of movement The operator can then input a target track adjuster position into an on-board microcontroller 50. The operator inputs the target track adjuster position using an input 40, for example, a potentiometer, a keyboard, a touchscreen, or a toggle switch, connected to the microcontroller 50.

Once the target track adjuster position is set, the microcontroller 50 monitors and automatically repositions the track adjuster 30 to maintain the target track adjuster position. If, for example, some external event causes a change in the track adjuster position, the microcontroller 50 automatically resets the track adjuster 30 to the target track adjuster position without further input from the operator.

Up and Down Tiller Pressure Control

Referring to FIG. 2, according to the invention, tiller pressure can also be controlled. A target pressure for a tiller 120 is set within a second microcontroller 51 using a second operator input 41, for example, a potentiometer. In addition to the target pressure, the hydraulic system may include an electrically operated pressure relief valve 130. Depending on the system capabilities, the release pressure may be set as a percentage above the target pressure, some predetermined increment above the target pressure, or at some predetermined pressure necessary to protect the system components.

Regardless of how the release pressure is set, should an overpressure condition be detected, the microprocessor 51 will open the relief valve 130 to bleed off hydraulic fluid thereby bringing the system pressure back into the target range. Similarly, if the microcontroller 51 detects an underpressure condition, it will automatically operate the appropriate hydraulic circuits and/or valves to feed hydraulic fluid into the cylinders controlling a rear lift frame position to reestablish the target pressure. The microcontroller 51 will automatically maintain the target pressure and prevent overpressure conditions despite fluctuations resulting from external events acting on the tiller 120 or the vehicle 1.

The movement involved in controlling the tiller pressure is the up and down movement, depicted by the arrow Y in FIG. 2, of the vehicle rear lift frame (not shown). Moving the frame up tends to lift the tiller 120, resulting in a corresponding reduction in the pressure the tiller 120 exerts against the snow pack. Similarly, lowering the rear lift frame tends to press the tiller 120 into the snow pack, resulting in a corresponding increase in the applied pressure. During the snow grooming work, depending on snow condition or desired snow finish, it may be useful to maintain a target pressure on the tiller 120. Again based on the desired result, the target pressure could be reduced to prevent the tiller 120 from digging too deeply into the snow pack or increased to provide for deeper tilling action. These two conditions will be called respectively up pressure and down pressure.

The second operator input 41, in this embodiment a potentiometer, in the cab 160 allows the operator to indicate to the microcontroller 51 the target pressure. The microcontroller 51 will then set the current and/or voltage applied to the electrically operated relief valve 130 according to the potentiometer position to set the maximum target pressure. Once the relief valve 130 is set, its mechanical features will allow it to open at all pressures in excess of the target pressure.

The microcontroller 51 monitors the actual pressure within the appropriate cylinders using one or more pressure sensors 140 installed at various points throughout in the hydraulic system. If the pressure is below the target pressure by a preset value, the microcontroller 51 activates a feed valve 150, which will feed oil into the hydraulic system, thereby increasing the pressure until the target pressure is reached.

This system will be activated according to the operation mode. The actual tiller direction and operation mode is controlled by a third microcontroller 52. The operation mode is communicated to the second microcontroller 51 using a signal 111, for example a digital signal.

Memory Card and Data Module

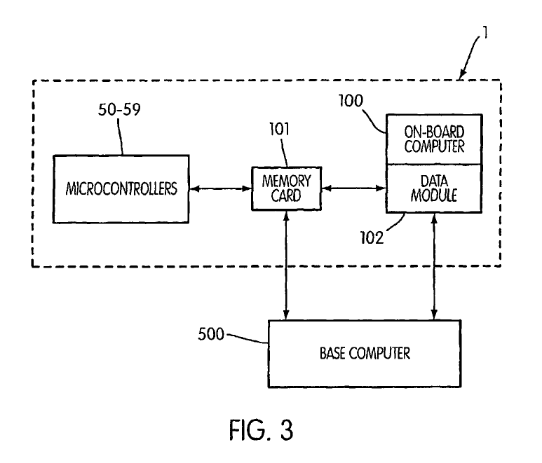

Referring to FIG. 3, a memory card 101, for example, a PCMCIA card, can be provided for collecting and transferring operational data and mapping data This allows operational and mapping data to be carried from a base computer 500 to the on-board computer and on-board microcontrollers 50-59 of the vehicle 1. Similarly, the memory card 101 allows operational and mapping data gathered during the operation of the vehicle I to be transferred from the vehicle 1 to the base computer 500. The memory card 101 also identifies a particular operator and controls the operation of the vehicle 1. For example, unless the operator number provided on the memory card 101 matches a number included on a validation list stored in the on-board computer 100, the computer 100 will not allow the engine start system to be enabled.

According to the present invention, the memory card 101 is a standard PCMCIA computer memory card. The on-board computer 100 in the vehicle 1 can access the memory card 101 through a data module 102, for example a PCMCIA module. In the operator validation mode, a particular file containing the operator ID is saved to the memory card 101. When the on-board computer 101 is turned ON, it sets a digital output to prevent engine cranking. It then reads the operator ID from the memory card 101. If there is a file on the memory card 101 and it matches a number already registered in the on-board computer 100 as a valid operator number, the output is closed and the engine may be started.

The on-board computer 100 may also be configured to save data to the memory card 101 periodically and/or upon the occurrence of a certain event or events. This data remains resident on the memory card 101 after it is removed from the on-board computer 100 and may be transferred to the base computer 500, for example a desktop computer, or a server for review and analysis.

Slope Angle Control and Display

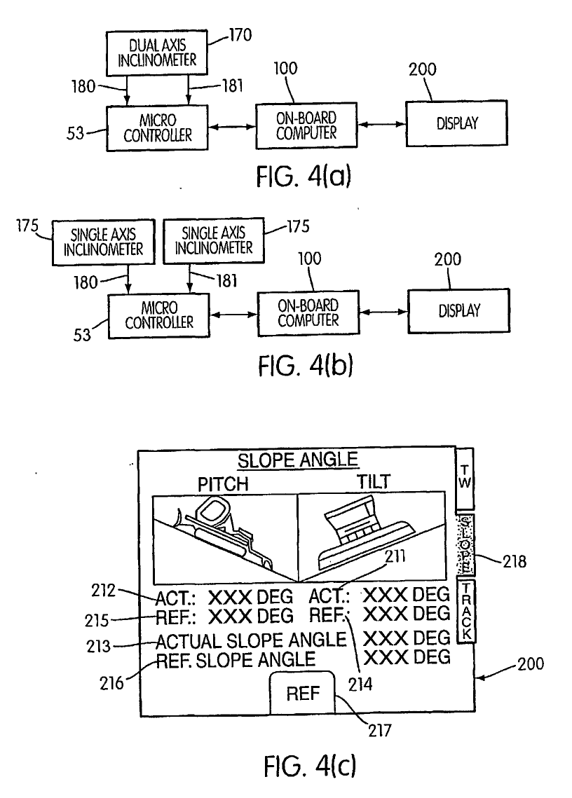

Referring to FIGS. 4(a)-4(c), slope angle control can also be provided, along with a display. Using a dual axis inclinometer 170 or a pair of single axis inclinometers 175, a pair of signals 180 and 181, for example 0-5V analog signals, corresponding to actual tilt and pitch angles 211 and 212, respectively, of the vehicle 1 are received by a fourth microcontroller 53. The inclinometers may be attached to the vehicle 1, the tiller 120 or to a plow (blade) attached to the front of the vehicle 1.

The actual tilt and pitch angles 211 and 212 are graphically depicted on a display 200, for example a touch screen display, connected to and controlled by the on-board computer 100. Based on the signals 180 and 181, the actual slope angle 213 is calculated and displayed to the operator on the display 200, by selecting a tab 218. In one embodiment, the operator can also set the present actual values of the tilt, pitch, and slope angles, 211-213, respectively, as new zero references 214-216, respectively, by selecting a reference (REF) button 217. Activating this option allows the operator to monitor the differential pitch, tilt and slope angles, thereby improving the operator's ability to monitor the progress of the grooming operation relative to the starting position. The vehicle 1 or the grooming device may also be automatically controlled on the basis of the signals 180 and 181, for example, to prevent the vehicle 1 or the grooming device from exceeding predetermined pitch, tilt, and slope angles.

Half Pipe Tool Angle Control and Display

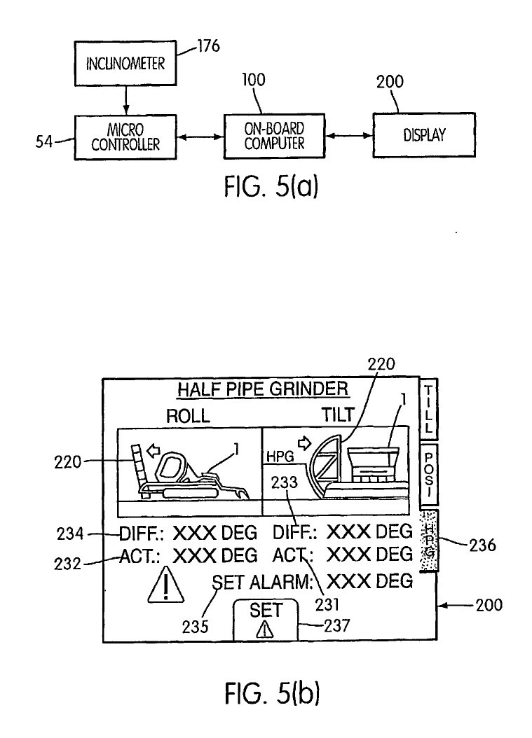

Referring to FIGS. 5(a) and 5(b), according to the invention, an additional inclinometer 176 may be installed on a halfpipe tool (grinder) frame 220 (shown graphically depicted on the display 200 in FIG. 5(b)) pivotally connected to the vehicle 1. This allows the operator to monitor the actual tilt and roll angles 231 and 232, respectively, being worked during the formation of a halfpipe tool by selecting a tab 236. The signal 182 from the additional inclinometer 176 also allows a fifth microcontroller 54 to calculate and display the differential angles 233 and 234, respectively, between the halfpipe tool tilt and roll angles 231 and 232 and the vehicle tilt and roll angles 211 and 212, which permits the halfpipe tool frame's position in reference to the vehicle 1 to be shown on the display 200.

The operator can set a target working angle and a tolerance 235, by selecting a button 237, that will be monitored by the microcontroller 54. If the difference between halfpipe tool frame actual angle and the target working angle 235 is higher then tolerance, an alarm can be sounded, be flashed on the display 200, and/or trigger a warning light. The signals 180-182 from the inclinometers 170, 175, and 176 and the target working angles provided by the microcontrollers 53 and 54, read from the memory card 101, or input in some other fashion, can also be used to automatically control the positioning of the halfpipe tool frame 220, either relative to the vehicle 1 or relative to a target slope.

Further, as with the slope angle, the operator can also have the option of setting the present actual values of the tilt and roll angles 231 and 232 as new zero values, allowing the microcontroller 54 to calculate and display the differential tilt and roll angles 233 and 234 as the grooming operation progresses.

Tiller Control and Display

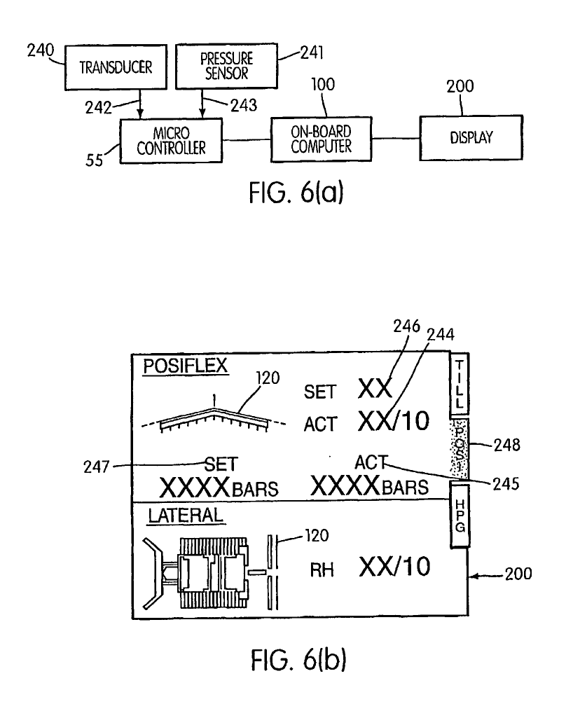

Referring to FIGS. 6(a) and 6(b), the invention also provides an operator with the ability to quickly ascertain various tiller parameters (chamber, lateral position, depth, etc.) displayed on display 200 during operation of the vehicle 1, by selecting a tab 248. A sixth microcontroller 55 collects and formats the information and provides the operator with a consolidated and simplified display 200. The relative positions of the tiller components are detected using a transducer 240 in the various positioning cylinders and the pressures applied in various positioning cylinders are detected using a pressure sensor 241.

Each of these parameters is monitored and compared by the microcontroller 55 against target position and pressure values 246 and 247. Each of the transducer 240 and the pressure sensor 241 provides a signal 242 and 243, for example a 0-5V analog signal, to the on-board computer 100 through the microcontroller 55. Each of the signals 242 and 243 can be calibrated so that the signals 242 and 243 received correspond to an actual position 244 and an actual pressure 245, or other parameter. Using the signals 242 and 243, the on-board computer 100 can also extrapolate the information to provide the operator more useful information. For example, by using the tiller oil pressure and the tiller rpm, the computer 100 can calculate the actual horsepower being consumed by the tiller 120. Similarly, the on-board computer 100 can use the collected information to approximate fuel consumption.

Figure-8 Count and Display

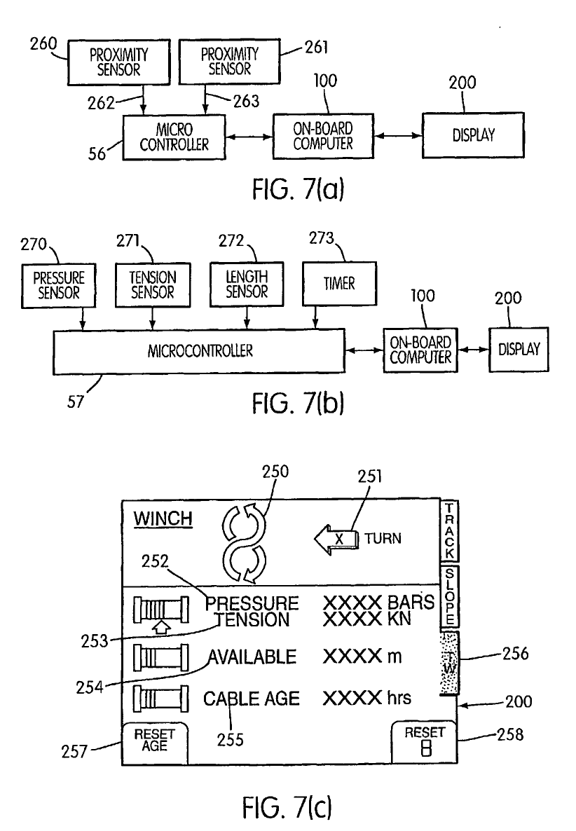

Referring to FIGS. 7(a) and 7(c), in certain situations noted above in the background description, the vehicle I can be equipped to carry a winch and a length of cable. The cable is, in turn, anchored above that portion of the slope upon which the vehicle 1 will be operating. During typical winch dependent operations, the operator attempts to balance the number of right and left turns to avoid subjecting the cable to excessive winding or twisting (and the associated damage and decreased cable life). Balancing the turns results in a vehicle track resembling a “figure-8” 250 (as graphically depicted on display 200) across the snowfield.

In this invention, the on-board computer 100 monitors the turns and upon selection of a tab 256 displays the differential 251 between right and left turns. Using this information, the operator can better balance the vehicle operation and increase the operating life of the cable.

Two proximity sensors 260 and 261 are installed on the winch tower base (the point at which the end of the cable is fixed). The sensors 260 and 261 are wired to the on-board computer 100 through a seventh microcontroller 56. A metal block, detectable by both sensors 260 and 261, is installed on the moving part of the tower of the winch. If the on-board computer 100 detects the output 262 from the sensor 260 followed by the output 263 from sensor 261, it will define the triggering motion as clockwise tower rotation. Similarly, if it detects the output 263 followed by the output 262, it will define the triggering motion as counter-clockwise rotation.

The computer 100 will kept track of these rotational inputs 262 and 263 and advise the operator as to the direction and number of turns necessary to return the cable to the desired untwisted condition. The figure-8 count may be reset by selecting a button 258.

Winch Control and Display

Referring to FIGS. 7(b) and 7(c), an operator may also quickly ascertain various winch parameters, for example, winch pressure 252, cable tension 253, cable length remaining on drum 254, cable age 255, that are displayed on the display 200. An eighth microcontroller 57 collects data from a pressure sensor 270, a tension sensor 271, a cable length sensor 272, and a timer 273 and formats the data and provides the operator with a consolidated and simplified display 200 similar to that for the tiller control described above with respect to FIGS. 6(a) and 6(b). In the event the cable is replaced, the cable age may be reset by selecting a button 257.

Weather Information Collection and Display

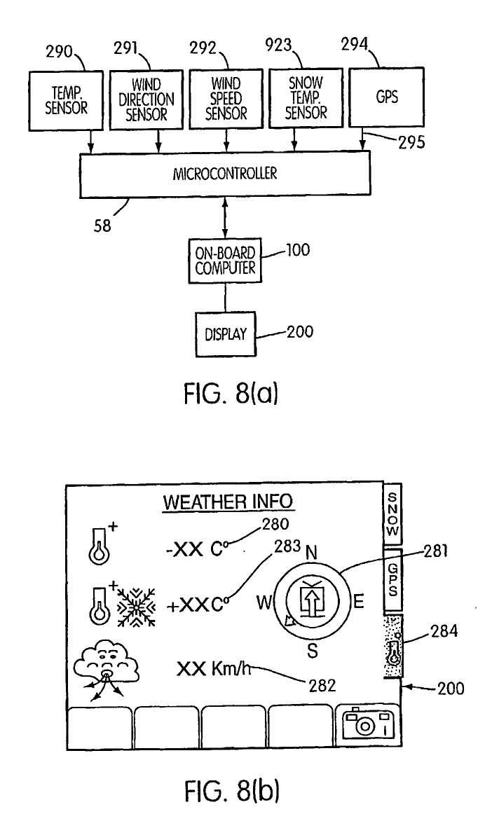

Referring to FIGS. 8(a) and 8(b), it is possible with this invention to provide dynamic weather information to the vehicle operator. Upon selection of a tab 284 the display 200 will show outside temperature 280, wind direction 281 (with calculation considering the vehicle orientation), wind speed 282 (with calculation considering actual vehicle movement) and snow temperature 283 provided by a temperature sensor 290, a wind direction sensor 291, a wind speed sensor 292, and a snow temperature sensor 293, connected to a ninth microcontroller 58. Wind speed and direction are calculated considering that the vehicle 1 is not a fixed weather station and calculations are required to compensate for the vehicle movement in order to provide the true wind speed and direction.

A global positioning system (GPS) 294 is used to detect and provide a signal 294 corresponding to the actual vehicle orientation. It should be appreciated that an electronic compass could also be used. In either case, the on-board computer 100 uses the speed and directional information provided by the sensors 291 and 292 to normalize the measured weather information and provide the true conditions. The wind direction 281 and wind speed 282 displayed on the display 00 are the resulting direction and speed (vehicle+wind). Because the vehicle direction and speed are known, vector calculations will provide wind information.

Snow Depth Information Collection and Display

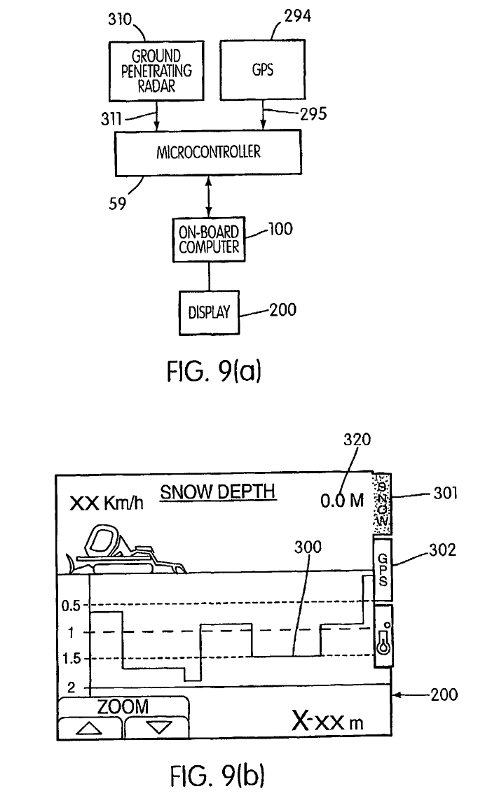

Referring to FIGS. 9(a) and 9(b), data indicative of the snow depth beneath the vehicle 1 may be monitored and collected in conjunction with the GPS signal 295 to generate a snow depth map. Upon selection of a tab 301, the snow depth will be displayed on the display 200. The preferred method of collecting this information is described in U.S. patent application Ser. No. 60/167,914, the contents of which are hereby incorporated by reference. The on-board computer 100 processes a signal 311 from ground penetrating radar (GPR) 310 through a tenth microcontroller 59 and provides the operator with a display of the underlying snow depth 320.

One possible representation of this information is illustrated in FIG. 9(b). The operator will be provided with a scan 300 of the snow depth along the vehicle's path that is based on time, for example, by tang a new measurement every predetermined number of milliseconds. It should also be appreciated, however, that instead of a scan based on time, the GPS 294 may be used by selecting a tab 302 to genie a grid base to be displayed on the display 200. The GPR 310 generates a signal 311, for example a 0-5V analog signal, that is provided to the on-board computer 100. The computer 100 processes the signal 311 and applies any necessary calibration or adjustment information to calculate the snow depth 320.

As shown in FIG. 9(b), in the top right corner of the display 200 the snow depth 320 may be constantly displayed while below a scan 300 provides a graphical representation of the historical snow depth data. According to the operator's needs, the length of time or the depth scale range displayed can be adjusted manually or can be allowed to self-range in response to the snow depths being measured. The display 200 can also be provided with an alarm should the GPR 310 detect some anomaly, e.g. stumps or rocks above the ground-snow interface, or snow depths less than the minimum required for the safe operation of the tiller 120 as presently configured.

Vehicle Trace Control and Display

It is also possible to monitor the position and progress of the vehicle I during its progress throughout the snow area being processed. According to one embodiment of the invention, the display 200 shows the vehicle's present location and a trace as an overlay against stored map information, stored for example in the on-board computer 100 or the memory card 101. Based on the GPS signal 295, the on-board computer 100 will draw the actual passage of the vehicle I on the display 200. While tracing the vehicle's passage on the display 200, the computer 100 will also record the map of the passage. The recorded information can be associated with a slope number and transferred via the memory card 101 to the base computer 500. The slope information can then be used to maintain a slope database that can be loaded via the memory card 101 into the on-board computer 100 of the vehicle 1 or other vehicles for use during future operations. The trace will then be on top of the slope map. This will allow the operator to locate the vehicle 1 more accurately with regard to the shape of the snowfield as it changes over the season Obstacle location can also be recorded. This information can then be used in future operations to inform the operators and avoid unnecessary damage to the vehicles.

Although the invention has been described in relation to the various exemplary embodiments outlined above, it should be appreciated that many changes may occur to one of ordinary skill in the art without departing from the spirit of the invention. For example, the microcontrollers 50-59 may be provided as a single microcontroller, and the display 200 may be provided as a plurality of displays. Accordingly, the scope of the invention is defined by the claims appended hereto.

I claim:

1. A tension adjustment system that adjusts the tension of a track arranged around at least two wheels of a vehicle, comprising:
a track adjuster that adjusts a spacing between the at least two wheels;
an operator input that accepts a target track adjuster position input by an operator; and
a controller that accepts the target track adjuster position input, monitors the track adjuster position, and automatically adjusts the track adjuster position to the target track adjuster position.

2. A tension adjustment system according to claim 1, further comprising a second operator input that accepts a second target track adjuster position input by the operator, wherein the controller automatically adjusts the track adjuster position to the second target track adjuster position.

3. A tension adjustment system according to claim 2, wherein the controller monitors slippage between the track and a snow surface, and upon detection of slippage alerts the operator to adjust the target track adjuster position by the second operator input.

4. A tension adjustment system according to claim 1, wherein the controller monitors slippage between the track and a snow surface, and upon slippage exceeding a preset value, automatically sets a second target track adjuster position that reduces the slippage.

5. A halfpipe toot control system that controls an angle of the halfpipe tool with respect to a vehicle to which the halfpipe tool is attached, comprising:
at least one inclinometer on the halfpipe tool that provides a signal indicative of the angle of the halfpipe tool relative to the vehicle;
an input that accepts a target angle and a tolerance;
a controller that monitors the signal from the at least one inclinometer and determines a difference between the angle and the target angle.

6. A halfpipe tool control system according to claim 5, wherein, upon detection of a difference larger than the tolerance, the controller provides an alarm.

7. A halfpipe tool control system according to claim 5, wherein, upon detection of a difference larger than the tolerance, the controller automatically adjusts the position of the halfpipe tool.

8. A halfpipe tool control system according to claim 5, wherein the at least one inclinometer is a dual axis inclinometer.

9. A halfpipe tool control system according to claim 5, wherein the at least one inclinometer is two single axis inclinometers.

10. A control system for a vehicle including an attached winch having a tower base to which a cable is attached and a block rotatable relative to the tower base, comprising:
two proximity sensors attached to the tower base that detect the rotation of the block and output signals upon detection of the block; and
a controller that receives the signals, determines the sequence of rotation of the block, and provides a display to an operator that informs the operator of a direction to turn the vehicle that prevents twisting of the cable.

11. A control system according to claim 10, wherein the vehicle is run in a figure-8 pattern during a grooming operation and the controller informs the operator to turn which direction to turn to maintain the figure-8 pattern.

12. A vehicle monitoring system that monitors a position of a vehicle over an area, comprising:
a global positioning system that provides a signal indicative of the vehicle's present location;
a computer that stores a map of the area and receives the signal;
a display that displays the map, the vehicle's present location on the map, and a trace of the signal over the map, wherein the computer records the map and the trace.

13. A vehicle monitoring system according to claim 12, wherein the map and the trace are transferred to a memory card that is received in the computer.

14. A vehicle monitoring system according to claim 12, wherein maps and traces of different areas and traces are transferable to the computer from the memory card.

15. A vehicle monitoring system according to claim 12, wherein the map is a topographic map.

16. A vehicle angle monitoring and display system, comprising:
at least one inclinometer installed on at least one of the vehicle and a grooming device attached the vehicle that provides at first signal indicative of a tilt angle of at least one of the vehicle and the grooming device with respect to a slope on which the vehicle is operating and a second signal indicative of a pitch angle of at least one of the vehicle and the grooming device with respect to the slope; and
a controller that monitors the signal and displays the tilt angle and the pitch angle.

17. A vehicle angle monitoring and display system according to claim 16, wherein the at least one inclinometer is a dual axis inclinometer.

18. A vehicle angle monitoring and display system according to claim 16, wherein the at least one inclinometer is two single axis inclinometers.

19. A vehicle angle monitoring and display system according to claim 16, wherein the at least one inclinometer is attached to a plow that is attached to the vehicle.

20. A vehicle angle monitoring and display system according to claim 16, further comprising an input that sets present values of the signals to zero, wherein the controller determines differential tilt and pitch angles upon setting of the values of the signals to zero.

21. A vehicle monitoring and display system according to claim 16, wherein the controller further controls at least one of the vehicle and the grooming device on the basis of the first and second signals.
